(19) United States
(12) Patent Application Publication
(10) Pub. No.: US 2002/0086175 A1
(43) Pub. Date: Jul. 4, 2002

(54) Self-adhesive composition

(76) Inventors: Roland Parg, Leverkusen (DE); Martin Hoch, Heinsberg (DE); Hermann Meisenheimer, Koln (DE)

Correspondence Address: BAYER CORPORATION, PATENT DEPARTMENT, 100 BAYER ROAD, PITTSBURGH, PA, 15205, US

(21) Appl. No.: 10/000,411

(22) Filed: Nov. 2, 2001

(30) Foreign Application Priority Data
Nov. 6, 2000 (DE) 10054866.0

(51) Int. Cl. C08L 31/02

(52) U.S. Cl. 428/516; 524/563; 428/412; 428/474.4; 428/475.2; 428/476.3; 428/483

(57) ABSTRACT

The invention relates to a self-adhesive composition (PSA) containing a copolymer of one or more α-olefins and vinyl acetate, wherein the vinyl acetate content is more than 50 wt. %, their use for the coating of substrates, as well as the coated substrates obtainable therefrom.

### FIELD OF THE INVENTION

The invention relates to a self-adhesive composition containing a copolymer of one or more α-olefins and vinyl acetate, the vinyl acetate content being more than 50 wt. %, their use for the coating of substrates, as well as the coated substrates obtainable therefrom.

Self-adhesive compositions within the scope of this invention are also understood to include hot-melt adhesive compositions or pressure sensitive adhesives (PSA).

### BACKGROUND OF THE INVENTION

DE-A1-195 27 288 discloses the use of a film provided with a self-adhesive composition, in which the film is a transparent copolymer film of vinyl acetate and ethylene, and the self-adhesive composition is based on acrylate, butyl rubber or SEBS or SEPS.

DE-A1-195 27 288 discloses a self-adhesive composition of poly(ethylene/vinyl acetate) with a loss factor tan δ of 0.6 to 1.0, measured at a temperature of 60° C. and a frequency of 10⁻² Hz, and of 0.4-0.7 measured at a temperature of 60° C. and a frequency of 10 Hz. The examples disclose a poly(ethylene/vinyl acetate) with a vinyl acetate content of 45 wt. % and a corresponding loss factor. The influence of the vinyl acetate content on the quality of the self-adhesive composition is not mentioned.

EP-A2-0 592 913 discloses a protective surface film without a self-adhesive composition, consisting of a copolymer of unsaturated polar comonomers and α-olefins.

Ethylene/vinyl acetate copolymers may be obtained commercially for example from Bayer AG under the trade names Levapren®.

### SUMMARY OF THE INVENTION

The subject of the present invention is a self-adhesive composition containing a copolymer of one or more α-olefins and vinyl acetate, in which the vinyl acetate content is more than 50 wt. % and the self-adhesive composition may, in addition, contain one or more additives selected from tackifying agents and other additives such as pigments, plasticizers, etc., fillers and crosslinking agents.

Suitable α-olefins are all α-olefins known to the person skilled in the art, such as ethylene, propene, n-butene, i-butene, pentene, hexene, 1-hexene, heptene, octene, 1-octene and their higher homologues. Obviously these olefins may also carry substituents, in particular C₁-C₅ hydrocarbons. Ethylene and propene are more preferred.

The vinyl acetate content is at least 50 wt. %, preferably at least 60 wt. %, more preferably at least 70 wt. %, and most preferably 80 wt. % or more.

Preferred copolymers have an average molecular weight M_{w} (weight average molecular weight determined by means of gel permeation chromatography (GPC)) in the range from 100,000 to 500,000 and polymer Mooney viscosities according to DIN 53 523 ML 1+4 100° C. in the range from 10 to 50, in particular 15 to 30. Furthermore the preferred copolymers are characterized by a melt flow index MFI (at 190° C.) of 3 to 50, in particular 5 to 25.

Preferred copolymers are Levapren® 500 HV, Levapren® 600 HV, Levapren® 700 HV and Levapren® 800 HV, which are obtainable from Bayer AG, Germany. These polymers contain in each case 50±1.5 wt. % of vinyl acetate, or 60±1.5 wt. % of vinyl acetate, or 70±1.5 wt. % of vinyl acetate or 80±2.0 wt. % of vinyl acetate. Furthermore, Levapren® VPKA 8865 with ca. 70 wt. % of vinyl acetate and an optimized molecular weight distribution is preferred. It may be advantageous to use the copolymers in powdered form. The powder may comprise silica, talcum, hydrophobic silica, chalk, etc.

The copolymers may also be employed as a blend of two or more different copolymers mentioned hereinbefore. It is also possible to use, as further blend components, copolymers as described in EP-A-0 976 775, preferably those with a high gel content.

The copolymers are produced by means of the copolymerization processes conventionally used in the art, but preferably by the so-called medium pressure solution process at pressures in the range from 1 to 400 bar with the aid of initiators that break down into free radicals. The copolymerization may in this connection be carried out continuously as well as batchwise. Such production processes are known to the specialist working in rubber technology and are described for example in the publication by V. E. Rohde, 141^{st} Meeting at the ACS, Louisville 1992, as well as in EP-A-0 341 499, DE-A-3 825 450 and EP-A-0 510 478.

The copolymers are preferably used in pure form. However, mixtures with other polymers such as NBR, NBR-PVC, PVC, PS, TPE, HNBR, EPDM, CR, NR may however also advantageously be used. These mixtures are preferably produced in solution and optionally may also be obtained commercially.

As a rule the self-adhesive composition according to the present invention does not contain tackifying agents. However, it may be advantageous for certain applications to use such tackifying agents. Petroleum resins are often used for this purpose. These resins are frequently produced by polymerization of a mixture of a distillate obtained by petroleum cracking that normally boils in the range from 25° C. to 80° C., and a monovinyl aromatic monomer with 8 to 9 carbon atoms in proportions such as to form a resin that contains 5 to 15 wt. % of the monovinyl aromatic compound measured by means of nuclear resonance analysis (NMR).

The distillate obtained from the petroleum cracking comprises a mixture of saturated and unsaturated monomers, the unsaturated monomers being monoolefins and diolefins, and some higher and lower materials such as C₆ olefins and diolefins may be present, although the unsaturated materials are predominantly C₅ olefins. The distillate may also contain saturated or aromatic materials that may act as polymerization solvents.

Further tackifying resins include terpene resins as well as those resins that are formed in the polymerization of unsaturated C₅-C₉ hydrocarbon monomers. Examples of commercially available resins based on a C₅ olefin fraction of this type are the tackifying resins Wingtack™ 95 and 115 (Goodyear Tire and Rubber Co., Akron, Ohio). Other hydrocarbon resins include Regalrez™ 1078 and 1126 (Hercules Chemical Co. Inc., Wilmington, Del.), Arkon™ resins such as Arkon™ P115 (Arakawa Forest Chemical Industries, Chicago, Ill.) and Escorez™ resins (Exxon Chemical Co., Houston, Tex.). Suitable terpene resins include terpene polymers such as polymeric resin-containing materials that are obtained by the polymerization and/or copolymerization of terpene hydrocarbons such as alicyclic, monocyclic and bicyclic monoterpenes and their mixtures. Commercially available terpene resins include the Zonarezm terpene resins of the B Series and 7000 Series (Arizona Chemical Corp., Wayne, N.J.). The tackifying resin may be ethylenically unsaturated, although saturated tackifying resins are preferred for those applications in which resistance to oxidation is important. Also suitable are the coumarone-indene resins marketed by Rhein Chemie, Germany, under the trade name Rhenosin™ (Rhenosin® types: C 10, C 30, C 90, C 100, C 110, C 120, C 150), hydrocarbon resins (Rhenosin® types: TP 100, TT 10, TT 30, TT 90, TT 100, TD 90, TD 100, TD 110), phenolic resins (Rhenosin® types: P 9447 K, P 7443 K, P 6204 K) as well as bitumen resins (Rhenosin® types: 145 and 260).

These resins are normally used in an amount in the range from 0.1 to 150 parts by weight per 100 parts of copolymer.

Additives may also be used in the self-adhesive composition in order to provide adhesives for special end uses. Such additives may include pigments, dyes, plasticizers, fillers, stabilizing agents, agents for absorbing UV radiation, antioxidants, process oils, etc. The amount of additive that is used may vary in the range from 0.1 to 50 wt. %, depending on the intended end use. Preferably, none of the additives that are used should significantly absorb radiation in the vicinity of the maximum absorption wavelength of a photopolymerization agent that may possibly be contained in the self-adhesive composition.

The self-adhesive composition according to the present invention may furthermore contain conventional fillers such as for example talcum, barytes, titanium dioxide, calcium carbonate, zinc oxide, silicates, silicic acids or kaolin or carbon black.

It is often advantageous if the self-adhesive composition also contains a photopolymerization agent that is activated by UV/VIS radiation, normally after the coating of the polymer. Suitable photopolymerization agents include, but are not restricted to, (a) aldehydes such as benzaldehyde, chromophore-substituted acetaldehyde and its substituted derivatives, (b) ketones such as acetophenone, benzophenone and their substituted derivatives, for example Sandoray™ 1000 (Sandoz Chemicals Inc., Charlotte, N.C.), (c) quinones such as benzoquinone, anthraquinone and their substituted derivatives, (d) thioxanthones such as 2-isopropylthioxanthone and 2-dodecylthioxanthone, and (e) specific vinylhalogenmethyl-sym-triazines substituted with a chromophore, such as 2,4-bis(trichloromethyl)-6,4′-methoxyphenyl-s-triazine and 2,4-bis(trichloromethyl)-6,3′,4′-dimethoxyphenyl-s-triazine. Since many such triazines produce HCl when activated, the addition of a basic compound to the polymer composition may furthermore be useful. The photoactive crosslinking agent is present as a rule in a range from 0.005 to 2 wt. %, preferably from 0.01 to 0.5 wt. %, and more preferably from 0.05 to 0.15 wt. % of the copolymer.

However, any crosslinking that may be necessary can also be carried out by means of high-energy radiation, such as for example α-, β- or γ-radiation in the absence of a crosslinking agent.

The present invention also provides a process for the production of the self-adhesive composition according to the present invention, characterized in that the copolymer is mixed in a mixing device together with the remaining constituents, or is brought into solution.

Such “solvent-borne” systems with solvents contain as a rule >5% of organic solvents, for example long-chain alcohols or neutral oils, or water.

The self-adhesive composition according to the present invention is suitable for application to an appropriate substrate for the production of adhesive tapes, labels, adhesive films, etc.

Further areas of application include: building/construction, bridges, roads, transport, woodworking and wood bonding, bookbinding, graphic industry, packaging industry, disposable articles, laminates, shoe manufacture, end customer adhesive applications, and in the sealant and insulating industry.

For application to substrates, the self-adhesive composition is applied, before a possible crosslinking, to the preferably primed surface of a suitable underlay (i.e. substrate). As a rule the layer thickness of the self-adhesive composition is in the range from 6 to 250 μm, in particular 10 to 100 μm. Preferred substrates are polyolefins such as LDPE, HDPE, PP, BOPP, polyurethanes, polyethylene terephthalates, PVC, ABS, polycarbonates, polyamides and polyesters.

The priming material is, for example, a neutralized hydrogenated colophony. By priming the substrate with this composition, the adhesive remains firmly adherent to the latter, even after the substrate composite has been applied to a surface. The primer composition according to the present invention produces a highly polar surface to which the self-adhesive composition can adhere.

Types of colophony that are suitable for the primer composition include polar colophony that contains acidic groups. Colophony that is at least partially hydrogenated is preferred. Commercially available colophony includes Foral™ AX hydrogenated colophony, Dresinol™ 205 colophony and Staybelite™ hydrogenated colophony (all from Hercules Chemical Co.), as well as Hypale™ colophony (Arakawa). Acid-containing colophony is highly polar and may be used in the present self-adhesive composition also as a surface-active agent and/or tackifying agent.

However, this type of colophony is used as a primer in order to improve the adherence of the existing self-adhesive composition to the substrate.

In order to neutralize the acid-containing colophony, the latter is, for example, reacted with a solution of a basic compound that can form a metal salt on reaction with the colophony. Suitable bases include alkali metal hydroxides (e.g. LiOH, NaOH, KOH) and alkaline earth metal hydroxides (e.g. Ca(OH)₂, Mg(OH)₂). On account of their solubility properties, alkali metal hydroxides, in particular KOH and NaOH, are preferred. Such hydroxides may be dissolved in a polar solvent such as water.

In order to react the colophony and the basic compound, both substances are as a rule dissolved in a solvent, preferably a polar solvent (because these compounds tend to exhibit polarity), most preferably water. The substances are then allowed to undergo an acid-base reaction. Since such reactions normally occur spontaneously, no special measures (for example elevated temperature or elevated pressure) are necessary, although they may be employed if desired. Normally stoichiometric amounts of colophony and base (or a slight excess of base) are used.

The neutralized colophony may optionally be mixed with an elastomeric compound before being applied to the substrate. Preferably, the elastomeric compound is highly compatible with the organic part of the colophony and with a saturating agent used in the tape substrate. Also, the elastomer is preferably dispersible in water. Since many substrates that are available contain crepe paper saturated with an acrylate polymer or with a styrene-butadiene rubber (styrene-butadiene rubber=SBR) and since acrylates and SBRs are compatible with the organic part of most types of hydrogenated colophony, they are preferred types of elastomers.

SBRs are known in the art and can be obtained from various suppliers. Common examples include Butofan™ NS209, NS222, NS 155 and NS248 rubber (BASF Corp., Parsippany, N.J. and Perbunan™ latices from Polymer Latex GmbH & Co. KG, Germany). Other suitable polymers include nitrile rubber such as the Hycar™ polymer series (B. F. Goodrich Co., Akron, Ohio) and (meth)acrylate polymers. Also suitable as elastomers are carboxylated NBR, HNBR and liquid NBR types, for example Therban® VBKA 8889, Krynac® K.X. 7.40, K.X. 7.50, K.X. 90 and K.E. 34.38 from Bayer AG.

A mixture of a rubber-based emulsion polymer, a colophony-based surface-active agent and a colophony-based tackifying agent is described in U.S. Pat. No. 5,385,965 (Bernard, et al.).

The list of suitable rubber-based polymers includes carboxylated statistical styrene-butadiene copolymers. Foral™ AX colophony compounds are included in the list of suitable tackifying resins.

If an elastomeric component together with a neutralized colophony is used in the primer, the two components may be mixed in any ratio in the range from 0.01:99.99 to 75:25, though a ratio of 50:50 (by weight) is preferred. (Other ranges are also suitable depending on the coating process that is employed.) The mixing is effected simply by adding the elastomer to the neutralized aqueous colophony mixture. The mixture can then be diluted to a desired concentration for coating. Preferred concentrations are in the range from 5 to 25 wt. %, more preferably in the range from 10 to 20 wt. %.

A preferred primer composition for a tape substrate saturated with SBR may be produced by neutralizing Foral™ AX colophony with an approximately stoichiometric amount of a strong base (for example an aqueous solution of KOH) in water at elevated temperature (e.g. 88° C.). After the neutralized colophony mixture has been removed from the heat source, it is combined with an approximately equal amount (by weight) of Butofan™ NS209 SBR and the resulting mixture is diluted in water to a solids content of about 15%. Also preferred are priming compositions with a minor amount of double bonds, such as ethylene-vinyl acetate copolymers with vinyl acetate contents below 40 wt. %, ethylene-α-olefin copolymers or ethylene-α-olefin-diene terpolymers.

The priming composition and/or the self-adhesive composition can be applied to a substrate (for example a tape substrate) by many different methods, including solvent coating, solvent spraying, emulsion coating, low pressure coating or other processes known to the person skilled in the art. Suitable substrates include polyolefin films (e.g. polyethylene and polypropylene films), in particular corona-treated polyolefin films, and paper saturated with elastomer. The suitable coating weight is in the range from 0.1 to 5 mg/cm², preferably from about 0.2 to about 1.0 mg/cm², and more preferably from about 0.3 to about 0.5 mg/cm². When the priming layer has been applied to a substrate, it is then preferably dried. This drying preferably takes place at elevated temperature, under reduced pressure, or both.

A further preferred method for the production of coated substrates is co-extrusion coating, which is normally carried out in a coating device with a melt film of the self-adhesive composition that is melted in an extruder and is applied via a flat-sheeting die to a substrate that may consist of one or more polymer layers. The composite that is thereby formed is then cooled in a cooling/press roll unit and smoothed. The composite strip material is then coiled in a corresponding coiling machine.

In the furthermore preferred lamination process the procedures of application of the coating composition to the carrier strip, smoothing and cooling, and stripping and coiling are carried out in a similar manner to the coating process. In the actual extrusion lamination, a prefabricated carrier strip is fed into a calender roll frame with 4 rollers. In this case, the carrier strip is coated before the first roller gap with a melt film that is melted in an extruder and applied via a flat-sheeting die. A second prefabricated strip is fed in before the second roller gap. The composite material that is, thereby formed, is smoothed on passing through the second roller gap, then cooled, stripped, and coiled in a coiling unit. These so-called cast films may be pretreated to improve the range of the composite bonding (carrier film/self-adhesive composition). The PO carrier film is typically either subjected to a corona oxidation or is coated with a silicone layer.

According to the furthermore preferred blowing/flat-sheeting die extrusion process, the self-adhesive composition and various polymers are generally first of all melted in different extruders under suitable conditions and are then combined in the form of melt streams with the formation of a multilayer melt stream in the extrusion apparatus. This is followed by the discharge, stripping and cooling of the multilayer molten strip containing the self-adhesive composition and the coiling of the composite material. A composite film is obtained in this way. The flat-sheeting die extrusion process is preferably employed in this connection.

Suitable polymers for these processes include, in particular, thermoplastics such as, for example, polyamides, polystyrene, polyesters, polycarbonates or polyolefins. Polyolefins are preferably used, for example ethylene homopolymers, propylene homopolymers or statistical propylene-ethylene copolymers. The production of such polyolefins may be carried out by conventional types of polymerization known to the person skilled in the art, for example by Ziegler-Natta polymerization, by polymerization with the aid of Phillips catalysts, by high pressure polymerization or by polymerization with the aid of metallocene-containing catalysts.

The coating/extrusion processes are as a rule carried out at temperatures in the range from 170° C. to 300° C., pressures of 250 to 400 bar, and mean transit times of 5 to 20 minutes. Since the copolymers in the melt and in the film have a high tendency to stick to all contact surfaces, it may be advantageous to coat the rollers used for the production of the composites as well as the stripping rollers with a material that is anti-adhesive with respect to the copolymers, for example with polytetrafluoroethylene. In this way appropriate strip tensions for the satisfactory coiling of the composite materials can, for example, be maintained.

The films coated with self-adhesive composition that are obtained in this way can advantageously be used in the transportation of automobiles.

Further important applications include the coating of glass, wood, ceramics, production of floor coverings or all types of lacquered articles, such as metal, alloys, as well as plastics such as polycarbonate, polyamide, polyester and ABS. Generally such applications are those in which high quality surfaces have to be protected for a certain time.

### EXAMPLES

Starting substances:

| | |
|---|---|
| Levapren ® 400 granules: | 40 wt. % VA, |
| | MFI (at 190° C.) 3-5 g/10 min |
| Levapren ® 600 HV granules: | 60 wt. % VA, |
| | MFI 3-5 g/10 min |
| Levapren ® 700 HV granules: | 70 wt. % VA, |
| | MFI 3-5 g/10 min |
| Levapren ® 800 HV granules: | 80 wt. % VA, |
| | MFI 3-5 g/10 min |

Levapren is an ethylene/vinyl acetate copolymer from Bayer AG, Germany.

Printing block film Tesaprint® 52310 PV3=adhesive film with acrylate-based adhesive layer on PVC substrate, from Beiersdorf.

| | |
|---|---|
| Escorene ® 19 from Exxon = | EVA with 19 wt. % VA |
| Elvax ® 40 from DuPont = | EVA with 40 wt. % VA |
| Koresin ® 40 from BASE AG = | phenol resin of tert-butylphenol + |
| | acetylene |

Processing

The granules were added directly to a Brabender twin-screw extruder of dimensions 30/25 D with 4 temperature zones and 4 pressure sensors, and with the following settings:

| | |
|---|---|
| T₁ at feed: 165° C. | P₁ at feed: 34.5 bar |
| T₂ at feed: 170° C. | P₂ at feed: 69.0 bar |
| T₃ at feed: 180° C. | P₃ at feed: 69.0 bar |
| T₄ at feed: 185° C. | P₄ at head: 34.5 bar |
| Flat-sheeting die outlet | |
| 20 r.p.m. of the screws | |

Stripping rate of the strip from the flat-sheeting die outlet 5 cm/sec.

Analysis

Desmomelt Rating (DR)

Quantitative evaluation of the surface state of the film and structure of the film (stripping, perforations, discolorations, streaking etc.) 1 (extremely good)-7 (poor)

90° Peel Test (90 P)

a) Stripping force of a substrate film relative to the applied self-adhesive composition (=90 PS) at a stripping rate of 100 mm/min.

b) Stripping force of the film with self-adhesive composition relative to the substrate (=90 PU) at a stripping rate of 100 mm/min.

measured in N/2 cm at test sample geometries of 2 cm×10 cm at room temperature after bonding for 3 days.

Substrate Films:

LDPE film from 4 P, Forchheim LDPE film 160.00 (LDPE)

Corona-treated LDPE film 160.00 from 4 P, Forchheim(C-LDPE)

Polyurethane film (PU)

Substrate:

| | |
|---|---|
| LDPE sheet | (LDPE-P) |
| PVC sheet | (PVC) |

In this connection, the self-adhesive composition is applied to the substrate film using the aforedescribed Brabender arrangement.

Tack Behavior (TA):

The tack behavior of the rubber mixtures was characterized by means of a tack measurement device developed by Bayer AG for basic investigations of the adhesion of polymers.

Physically, the procedure can be subdivided into a contact process and a separation process. The stress loading of the adhesive samples takes place in the so-called front tear-off test.

During the contact phase, an adhesive bond is formed between polymer and substrate by application of a pressure force. Important parameters in this respect are the contact time, pressing force and temperature, which may vary within wide ranges. The separation of the composite is then carried out under the action of a tensile force. The mean separating force and the area integral of the force/separation path curve, which is termed the separation work, are evaluated. At the same time the behavior of the force/separation path curve was investigated, which may either be very smooth or have a very zigzag appearance. The difference between the highest measured separating force and the lowest is termed the variance. The measurement procedure is carried out using test punches. The polymers to be investigated are secured to suitable carriers and are heated on a heatable surface to the measurement temperature, which is monitored using an IR temperature measurement device. The punches consist either of test materials (steel, aluminium, various plastics) or are prepared using the corresponding polymer, so that measurements of self-adhesion may also be made. The tack measurements were carried out under the following experimental conditions:

the measurements were carried out at room temperature and 40° C. Strips of size 15 cm×2.5 cm were cut from the test material and bonded to an aluminium sheet, which served as test carrier.

In order to be able to carry out a measurement of polymer against polymer, circular test specimens of diameter 12 mm were cut out from the test material and bonded to VA punches using quick-acting adhesive (cyanoacrylate adhesive). Ten individual measurements were carried out on each part, in each case relative to VA punches and relative to coated punches. The parts were brought into contact at a pressure of p=5 bar over a period of 10 seconds. After this contact time, the composite was separated at a stripping rate of 2 mm/sec.

Examples 1 to 8 are shown in Table 1.

TABLE 1

| | | | 90 PS | 90 PU | 90 PS | 90 PU | 90 PU | TA | TA | |
|---|---|---|---|---|---|---|---|---|---|---|
| | | | LDPE | LDPE | C-LDPE | C-LDPE | PU | LDPE | S-LDPE | |
| Example | Material | DR | LDPE-P | LDPE-P | LDPE-P | LDPE-P | PVC | LDPE-P | LDPE-P | Variance |
| 1 | Levapren ® 400 | 2 | — | — | — | — | — | 0.3 | 0.1 | n.m. |
| 2 | Levapren ® 600 HV | 2 | 1 | 2 | 1 | 2 | 3 | n.m. | n.m. | 0.3 |
| 3 | Levapren ® 700 HV | 2 | 2 | 3 | 2 | 3 | 5 | 0.45 | 0.15 | 0.3 |
| 4 | Levapren ® 800 HV | 2 | 3 | 4 | 3 | 4 | 7 | 0.55 | 0.2 | 0.3 |
| 5 | Levapren ® 700 HV* + | 4 | 0.8 | 1 | n.m. | n.m. | n.m. | — | — | 0.5 |
| | 10 wt. % Koresin | | | | | | | | | |
| 6 | Escoren ® 19 | 6 | — | — | — | — | n.m. | — | — | n.m. |
| 7 | Elvax ® 40 | 5 | — | — | — | — | n.m. | 0.2 | 0.1 | n.m. |
| 8 | Tesaprint | n.m. | n.m. | 4-5 | n.m. | n.m. | n.m. | 0.6 | n.m. | 2 |

*referred to total mixture
n.m. = not measured

Evaluation

Example 8 represents a commercially obtainable PSA adhesive structure. Printing block films serve as the maximum bonding force for PSA composites.

For applications in which a residue-free stripping of the film is necessary, the variance of the stripping force around the mean value (90 PU) given in Table 1 must also be taken into account. This is shown in Table 1 in N /2 under variance and represents the Δ between 90 PUₘₐₓ-90 PUₘᵢₙ. The greater the variance, the more likely it is that residues will remain.

It is clear from the examples that EVA self-adhesive compositions are suitable for blow film coating as well as for cast film coating. EVA self-adhesive compositions with a VA content of more than 50 wt. % exhibit a high bonding force at room temperature and should, therefore, be defined as pressure sensitive adhesives (PSA). This is associated with an advantageous residue-free stripping. Polyurethane substrates containing a self-adhesive composition according to the present invention are obviously particularly advantageous.

Variation of the Adhesive Force

The following Examples 9 to 11 show that the bonding force can advantageously be varied by means of the molecular weight (here expressed by the MFI).

TABLE 2

| | | TA-LDPE |
|---|---|---|
| Example | Material | LDPE-P |
| 9 | Levapren ® 800 HV MFI = 3-5 | 0.55 |
| 10 | Levapren ® VP KA 8896 MFI = 15-30 | 0.4 |
| 11 | Levapren ® 456 MFI = 15-30 | 0.4 |

Furthermore, it is possible to vary the bonding force by using various termonomers such as acrylates, in particular 2-ethylene/hexyl acrylate, styrene, butadiene, isoprene etc.

The bonding force can be adjusted by using suitable mixtures of the copolymers according to the present invention so that a minimum bonding force as well as also a maximum bonding force can be achieved, depending on how much force will be required in order to strip the adhesive film from the surface.

By choosing a suitable copolymer according to the present invention as regards VA content, molecular weight (measured for example as MFI value), or blends thereof, a hitherto unobtainable broad range of substrate films can be provided with adhesive layers in order to protect all types of surfaces.

Although the invention has been described in detail in the foregoing for the purpose of illustration, it is to be understood that such detail is solely for that purpose and that variations can be made therein by those skilled in the art without departing from the spirit and scope of the invention except as it may be limited by the claims.

Although the invention has been described in detail in the foregoing for the purpose of illustration, it is to be understood that such detail is solely for that purpose and that variations can be made therein by those skilled in the art without departing from the spirit and scope of the invention except as it may be limited by the claims.

What is claimed is:

1. A self-adhesive composition comprising a copolymer of one or more α-olefins and vinyl acetate, wherein the vinyl acetate content is more than 50 wt. % and the self-adhesive composition may additionally contain one or more additives selected from the group consisting of tackifying agents, additives, fillers and crosslinking agents.

2. A self-adhesive composition according to claim 1, wherein the vinyl acetate content is more than 60 wt. %.

3. A self-adhesive composition according to claim 1, wherein said additives does not contain any tackifying agents.

4. A process for the production of the self-adhesive composition comprising a copolymer of one or more α-olefins and vinyl acetate, wherein the vinyl acetate content is more than 50 wt. % and the self-adhesive composition may additionally contain one or more additives selected from the group consisting of tackifying agents, additives, fillers and crosslinking agents comprising the step of mixing the copolymer with the remaining constituents in a mixing device.

5. A product containing a self-adhesive composition comprising a copolymer of one or more α-olefins and vinyl acetate, wherein the vinyl acetate content is more than 50 wt. % and the self-adhesive composition may additionally contain one or more additives selected from the group consisting of tackifying agents, additives, fillers and crosslinking agents.

6. A product containing a self-adhesive composition according to claim 5, wherein said product is an adhesive tapes, labels and adhesive films.

7. A coated substrate comprising a self-adhesive composition comprising a copolymer of one or more α-olefins and vinyl acetate, wherein the vinyl acetate content is more than 50 wt. % and the self-adhesive composition may additionally contain one or more additives selected from the group consisting of tackifying agents, additives, fillers and crosslinking agents.

8. A coated substrate according to claim 7, wherein the vinyl acetate content is more than 60 wt. %.

9. A coated substrate according to claim 7, wherein said additives does not contain any tackifying agents.

10. A coated substrate according to claim 7, wherein the substrate is selected from the group consisting of ABS, polyolefin films, corona-treated polyolefin film, paper saturated with elastomer, polyamide, polystyrene, polyester, polycarbonate, ethylene homopolymer, propylene homopolymer and statistical propylene/ethylene copolymers.

11. A process for the production of a coated substrate containing a self-adhesive composition which comprising a copolymer of one or more α-olefins and vinyl acetate, wherein the vinyl acetate content is more than 50 wt. % and the self-adhesive composition may additionally contain one or more additives selected from the group consisting of tackifying agents, additives, fillers and crosslinking agents, comprising the step of applying the self-adhesive composition is applied to a substrate.

12. A process according to claim 11, wherein the application is performed by solution coating, solution spraying, emulsion coating or low pressure coating.

13. Process according to claim 1, wherein the application is performed by co-extrusion coating, lamination processes or blowing/flat-sheeting die extrusion processes.
